(19) United States
(12) Patent Application Publication
(10) Pub. No.: US 2026/0105301 A1
(43) Pub. Date: Apr. 16, 2026

(54) LARGE WIRELESS MODEL (LWM): A FOUNDATION MODEL FOR WIRELESS ENVIRONMENTS

(71) Applicant: ARIZONA BOARD OF REGENTS ON BEHALF OF ARIZONA STATE UNIVERSITY, Scottsdale, AZ (US)

(72) Inventors: Ahmed Alkhateeb, Chandler, AZ (US); Sadjad Alikhani, Tempe, AZ (US); Gouranga Charan, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 19/333,849

(22) Filed: Sep. 19, 2025

Related U.S. Application Data
(60) Provisional application No. 63/696,576, filed on Sep. 19, 2024.

(51) Int. Cl. G06N 3/08; G06N 3/045

(52) U.S. Cl. CPC G06N 3/08; G06N 3/045

(57) ABSTRACT

System and method include a Large Wireless Model (LWM), a task-agnostic, Transformer-based, model pre-trained on large-scale wireless environment datasets. This self-supervised model generates contextualized wireless data embeddings in real time, enhancing the performance of a wide range of downstream tasks in wireless communication and sensing systems. LWM may learn from large-scale wireless data and adapt to diverse tasks with limited data.

### CROSS-REFERENCE TO RELATED APPLICATIONS

This application claims the benefit of U.S. Provisional Patent Application Ser. No. 63/696,576, filed Sep. 19, 2024, the disclosure of which is incorporated herein by reference in its entirety.

### FIELD OF THE DISCLOSURE

The present disclosure is directed to modeling wireless communications, and more specifically, a foundational model for wireless communications.

### BACKGROUND

Next-generation wireless networks beyond 5G and 6G face challenges in meeting increasing demands for data rates and requirements on mobility, reliability, latency, and energy efficiency. Using high-frequency bands in millimeter wave (mmWave) and sub-terahertz, employing large-scale multiple-input multiple-output (MIMO) systems, and densifying the networks are approaches for satisfying data rate requirements. These approaches use high-dimensional signal processing and intricate network management. What are needed are techniques for wireless communications network modeling and optimization.

Current systems rely on large antenna arrays, the operation over high frequency bands in mid-band, millimeter wave (mmWave), and sub-terahertz, the support of massive number of communicating and sensing devices of various quality of service requirements, and the densification of network infrastructure nodes. Further, these wireless communication and sensing systems interact with each other, from coordination and integration to assisting each other.

Traditional modeling techniques, such as statistical models and optimization-based approaches may struggle to address these challenges. These methods may rely on simplified models or scenario-specific features, failing to generalize across the diverse and dynamic environments of present and future wireless communication networks. The methods may not capture interference patterns in small-cell networks or may lack scalability to high-dimensional MIMO systems. Deep learning may be used as a data-driven solution for optimizing network performance, resource allocation, and signal processing, but may require labeled datasets, which are may be scarce in wireless networks. Deep learning models like Convolutional Neural Networks (CNNs) and Recurrent Neural Networks (RNNs) may struggle with specific aspects of wireless communication tasks. CNNs may not capture temporal dependencies efficiently, while RNNs may struggle with long-term dependencies and real-time computational efficiency. What are needed are adaptable modeling approaches in wireless communications.

### SUMMARY

A large wireless model (LWM) designed for wireless communication and sending may include a task-agnostic framework with pre-training on large-scale synthetic data. As a task-agnostic model, LWM may extract features for multiple downstream tasks, facilitating complex problem-solving with limited labeled data. A LWM may use Transformer models with multi-head attention mechanisms to capture complex spatial and temporal relationships (time/space/frequency) in wireless channel data. A Transformer architecture is a neural network architecture based on a multi-head attention mechanism, in which text is converted to tokens, and the tokens are converted into vectors. A multi-head attention mechanism enables a model to simultaneously process subspaces of the input data to determine relationships and information from different parts of the input data. LWM may learn context-aware embeddings that can be utilized for various downstream wireless communication tasks, such as channel estimation, beamforming, and interference management. LWM may be pre-trained on, for example, but not limited to, synthetic datasets generated through raytracing simulations covering wireless scenarios, and/or wireless channel datasets. This approach enables the model to capture properties of wireless propagation and network dynamics, which can be transferred to real-world scenarios, even with limited task-specific data. LWM addresses the challenges of limited labeled data, complex spatial-temporal dependencies, and generalization across wireless environments. The system and method provide a foundation model for wireless channel embeddings, capable of extracting features from wireless environments in diverse environments. LWM may enable generalization to wireless scenarios with limited task-specific data.

Foundation models provide large-scale pre-training followed by task-specific fine-tuning. Foundation models, for example, but not limited to, Bidirectional Encoder Representations from Transformers (BERT) in audio processing, use Transformer architectures with multi-head attention mechanisms to capture relationships in data. The pre-training phase may involve large datasets and learning objectives such as, for example, but not limited to, self-supervised masked language modeling and next-sentence prediction, and/or contrastive learning and masked prediction tasks for audio understanding. The pre-training process enables foundation models to learn contextual representations of their input domains. The attention mechanism enables dynamic focus on parts of the input. The resulting pre-trained model may be fine-tuned on tasks with limited task-specific data. The resulting model includes a transfer learning capability and an ability to capture long-range dependencies and generalize across scenarios.

Models that process sequences sequentially, for example, recurrent neural networks (RNNs) or convolution neural networks (CNNs), are different from Transformers that look at all parts of a sequence simultaneously. The parallel processing of Transformers enables the elements to relate to each other, capturing dependencies across an input sequence. For example, in a sentence, words like “bank” and “river” might appear far apart, but self-attention enables the model to understand their association when the context implies a natural setting, rather than financial. By calculating attention scores between each pair of words, Transformers enable the model to understand nuanced meanings and relationships.

In language models like BERT, each word token in a sentence is converted into a dense vector representation (embedding) and is associated with a query, key, and value. The attention mechanism calculates a weighted average of these values for each word, where the weights are derived from the similarity between the queries and keys. This process allows the model to focus on important words and phrases depending on context. In generative pre-trained transformer (GPT) models, the attention mechanism understands contextual nuances and generates text. Given a prompt, the GPT model iteratively predicts the next word by attending to all previous words, ensuring that the generated words maintain context. The process enables the model to construct text using the self-attention mechanism to understand complex dependencies.

In vision models, Transformers use a self-attention mechanism to capture spatial relationships across pixels or image patches, providing an alternative to CNNs. For example, in Vision Transformers (ViTs), an image is divided into small, fixed-size patches, each of which is flattened and linearly embedded, similar to tokens in a sentence. These embeddings are then processed in parallel, allowing the Transformer to learn relationships between regions of an image. This capability is useful for tasks such as recognizing objects within complex backgrounds or interpreting spatial patterns across a scene. This process enables ViTs to recognize patterns and perform tasks such as object detection, image segmentation, and visual question answering.

Foundation models that process text and images may be adapted to process wireless signals that have complex-valued data, rapid temporal variations, and domain-specific noise patterns. A foundation model for wireless communications and sensing may be pre-trained on, for example, but not limited to, synthetic datasets generated through ray-tracing simulations or real-world data). A foundation model may capture properties of wireless propagation and network dynamics and may enable performance across wireless environments, even with limited task-specific data.

LWM is a task-agnostic model for feature extraction in wireless channels. LWM includes a self-supervised Transformer architecture with multi-head attention mechanisms, and is pre-trained on a large dataset of wireless channels. LWM processes input channels in patches, enabling LWM to extract features for various wireless communication and sensing tasks. LWM may capture patterns and provide contextual representations of wireless environments. LWM is a transformer-based foundation model for wireless channels. It is designed as a universal feature extractor capable of supporting multiple downstream tasks, including classification, prediction, and regression. In some configurations, input channels are segmented into 1D patches. In some configurations, input channels are segmented into 2D patches that span antenna and subcarrier dimensions. Various configurations of LWM may enable toggling of parameters such as, for example, but not limited to a maximum sequence length, internal embedding size, attention heads per transformer layer, training scenarios combining variations in environment layouts, base-station placements, and antenna-subcarrier (N, SC) dimensions, sample size, and antenna-subcarrier configurations. In some configurations, scenarios may be partitioned into zones that are mapped to (N, SC) buckets to prevent model bias toward any single input shape. In some configurations, channels with similar effective dimensions (N×SC) are grouped into buckets, eliminating the need for excessive padding, and improving memory efficiency, training throughput, and stability. In some configurations, 20% of each bucket may be reserved for validation, ensuring that performance metrics faithfully reflect generalization across all input sizes rather than being dominated by one configuration. A multi-configuration, bucketed pretraining capability may enable transfer of embeddings across a variety of antenna and subcarrier counts, and may improve scalability to larger systems without architectural modifications, yielding embeddings that remain stable as input dimensions vary. Bucket-based batching may reduce memory consumption by eliminating padding. Attention head reduction and optimized training routines may reduce overall training cost.

In some configurations, parameters such as, for example, but not limited to, the masking ratio, the loss function, and the optimizer can be set in LWM. In some configurations, LoS/NLOS evaluation may be used to evaluate LWM, considering multiple channel sizes, fine-tuning the model, testing performance in noisy environments, and comparing classification token embeddings and channel embeddings against a baseline model trained on raw channels. In some configurations, multiple fine-tuning strategies, including frozen embeddings, partial fine-tuning of the last layers, and full end-to-end training are enabled.

LWM may capture spatiotemporal dependencies in wireless channels for static channel representations, and the dynamic evolution of channels resulting from mobility, multipath propagation, and Doppler effects. LWM is built on Transformer-based architectures with physics-aligned attention mechanisms to learn universal channel representations. LWM may operate in the raw channel space or the Angle-Delay (AD) domain, using the inherent sparsity and structure of wireless propagation. The AD domain provides a sparse, structured, and interpretable view of propagation, highlighting multipath components and enabling learning.

LWM may include a sparse spatio-temporal attention (SSTA) that combines neighborhood attention, content-aware routing, and multi-scale positional encoding to capture local and long-range spatiotemporal dependencies. LWM may include masking and sequence objectives aligned with wireless propagation physics, such as energy-aware and spatial-temporal masking, to guide representation learning. LWM may provide a pretrained backbone that may be adapted with lightweight heads to various of wireless communication and sensing tasks. LWM may include progressive pretraining that gradually increases task difficulty, allowing the model to first capture local correlations and later extend to long-range dependencies.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for extracting features in a wireless environment, where the wireless environments may include wireless communications and sensing. The method includes transforming complex-valued wireless environment input into a format compatible with a deep learning model. The transforming includes processing data from the wireless environment into patches, embedding the patches into an embedding dimension, and adding positional encodings to the embedded patches. The method also includes pre-training a large wireless model to develop a universal feature extractor. The method also includes providing the data from the wireless environment to the pre-trained large wireless model to extract the one or more features. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated in and constitute a part of this specification, illustrate aspects of the present teachings and together with the description, serve to explain the principles of the present teachings.

FIG. 1A is a pictorial illustration of offline pre-training and an online embedding generation process for a large wireless model in accordance with embodiments the present disclosure;

FIG. 1B is a graphic illustration of a multi-head attention mechanism in accordance with embodiments of the present disclosure;

FIGS. 2A-2D are tables of beam prediction F1-score performance between raw channels and their inferred LWM embeddings, based on a total of 10388 training raw channels, and highlights their relative effectiveness;

FIGS. 3A-3D are tables of a comparison of performance between raw channels and large wireless model embeddings in training a model for beam prediction, evaluated across different codebook sizes and varying amounts of training data;

FIG. 4 is a graphical representation that illustrates a comparison between F1-scores for LoS/NLOS classification using models trained on raw wireless channels and LWM embeddings across different percentages of the training samples;

FIG. 5 is a pictorial illustration of the distribution of users in the DeepMIMO Denver scenario based on their LoS/NLOS status (top row) and strongest discreet Fourier transform (DFT) beam index among eight beams (bottom row); and

FIG. 6 is a flowchart of a method in accordance with embodiments of the present disclosure;

It should be noted that some details of the figures have been simplified and are drawn to facilitate understanding rather than to maintain strict structural accuracy, detail, and scale.

### DESCRIPTION

Reference will now be made in detail to the present teachings, examples of which are illustrated in the accompanying drawings. In the drawings, like reference numerals have been used throughout to designate identical elements. In the following description, reference is made to the accompanying drawings that form a part thereof, and in which is shown by way of illustration specific examples of practicing the present teachings. The following description is, therefore, merely exemplary.

LWM may include LoS/NLOS classification, beam prediction, channel interpolation, and channel estimation. LWM supports multiple antenna-subcarrier configurations using linear embedding layers and training on heterogeneous channel dimensions. LWM supports complex-valued, hardware-dependent channel matrices without rescaling. In LWM, channels with equivalent effective size are grouped into buckets, eliminating the need for padding. Equivalence classes are defined across antenna-subcarrier grids. Buckets may include validation splits to enable performance tracking. Training is possible on variable-size inputs to reduce memory and computation cost, and enable scaling to large channels. In LWM, scenarios may be partitioned into zones that are mapped to balanced input size buckets to diminish model bias toward dominant environments. Ray-traced, propagation-aware channel data with zoning is not available in other large model applications. In LWM, input channels may be segmented into two-dimensional patches spanning antennas and subcarriers. Real and imaginary components may be handled separately before embedding. The segmentation may capture joint spatial-frequency correlations inherent in channel matrices and provide representation of propagation physics. LWM may enable toggling of the masking ratio, may use an AdamW optimizer with a cosine learning rate schedule, and may use applied symmetric masking across real and imaginary patches. These features may enable the model to learn long-range dependencies, and may decrease a likelihood of leakage between real and imaginary components. Both components of complex-valued channel data may be masked to align with wireless physics. LWM fitness for use evaluation may be related to benchmarks of wireless latency constraints such as channel coherence times and beamforming deadlines. In LWM, channels may be transformed into the AD domain and used as input to LWM for example, for pretraining, producing sparse and interpretable tensors. LWM may include SSTA that may combine structured neighborhood attention, content-aware routing, and multi-scale encoding to capture both local and global channel dynamics. SSTA may model Doppler and mobility effects, reduce computational cost, and match wireless temporal evolution patterns. Sparsity may be based on wireless propagation physics. In LWM, masking and learning objectives may be aligned with propagation properties, such as energy-aware masking and spatio-temporal neighborhood masking, which may reduce sample complexity. The aligned masking and learning objectives may be adapted to multipath channel propagation. LWM training may begin with short temporal windows, and progressively increase the sequence length to capture Doppler and mobility to prevent instability during training, and aligning curriculum stages with propagation scales. LWM may be deployable in scenarios with varied data and compute budgets, for example, in low-resource base stations or user equipment, because three strategies are supported—frozen embeddings, tuning of last layers, and full fine-tuning—to enable wireless tasks where labels and computational resources are may be scarce.

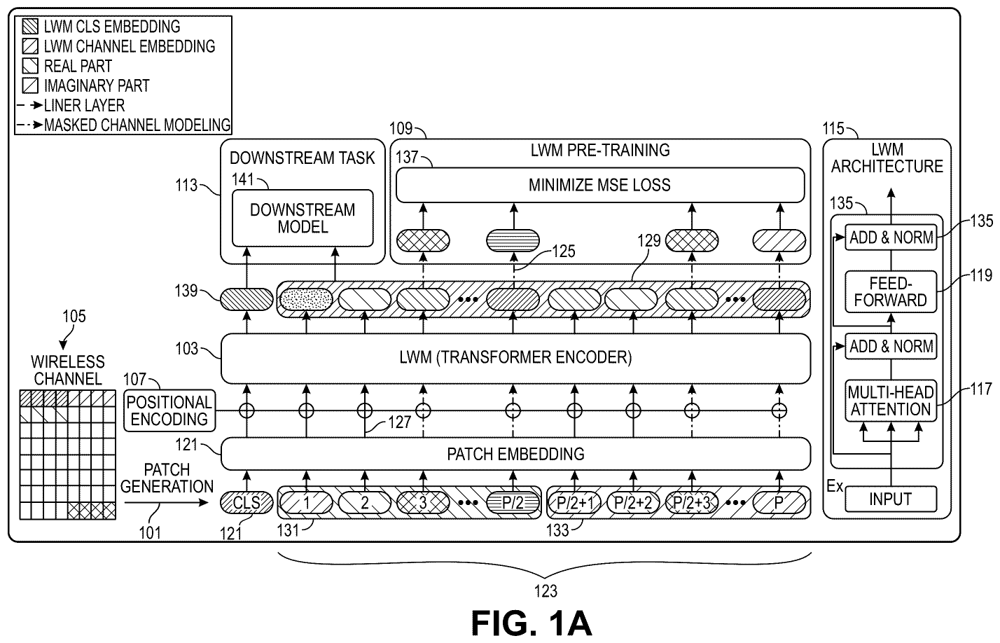

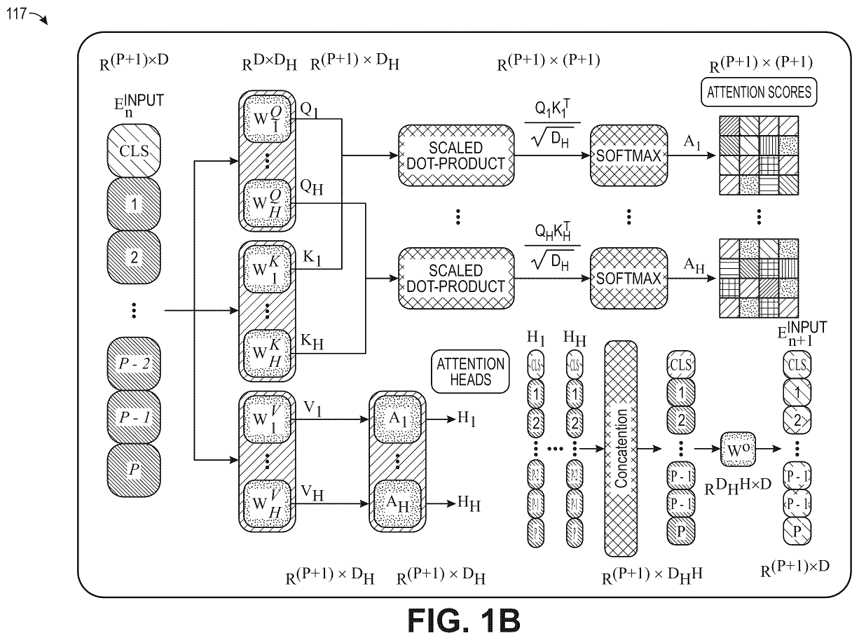

Referring now to FIG. 1A, input channels are preprocessed to align with a Transformer input format and to facilitate a self-supervised pre-training method. LWM includes patch-based processing, self-supervised pre-training, multi-head attention, and task flexibility and transferability. With respect to patch-based processing, wireless channels are segmented into patches. The patch-based structure enables spatial and spectral dependencies to be encoded to mimic human perception of relevant wireless features. With respect to self-supervised pre-training, LWM is trained on a large dataset of unlabeled wireless channels using self-supervised techniques. Masked channel modeling and an attention mechanism enables LWM to learn to capture structural relationships within the data without relying on labeled datasets. With respect to multi-head attention, the attention mechanism in LWM allows it to focus on patterns in wireless channels, dynamically assigning importance to different parts of the input. With respect to task flexibility and transferability, the representations produced by LWM make it possible to apply the model to downstream tasks with minimal or no fine-tuning. LWM can generalize across scenarios and geographic regions, even when task-specific data are sparse or highly variable.

The LWM steps include, but are not limited to including, patch generation, patch classification, channel embedding, masked channel modeling, self-attention, feed-forward network, layer normalization, and residual connections.

With respect to patch generation 101, the channel 105 is divided into fixed-size patches, which are linearly embedded 111 and combined with positional encodings before being passed through a Transformer encoder 103. During self-supervised pre-training 109, some embeddings are masked, and LWM uses self-attention to extract deep features, allowing the decoder to reconstruct the masked values. For downstream tasks 113, the generated LWM embeddings 111 enhance performance. LWM architecture 115 includes multi-head attention 117 and feed-forward 119.

Continuing to refer to FIG. 1A, unlike RNNs, Transformers receive input simultaneously. Each channel is fed in a patch-based format. Each channel H ∈ [symbol] is split into patches 131. The real and imaginary components are separated and flattened, and each part is divided into patches as follows:
(1) Real and imaginary components of channel H are separated into real and imaginary components

$${H}_{real} = ℛ ( H ) , \qquad ( 1 a )$$

$${H}_{imag} = 𝒥 ( H ) , \qquad ( 1 b )$$

$$where {H}_{real} , {H}_{imag} ∈ {ℝ}^{M \times N} .$$

(2) Hᵣₑₐₗ and H_{imag} are flattened into vectors using a vectorization operator, as follows

$${h}_{real} = vec ( {H}_{real}^{T} ) , \qquad ( 2 a )$$

$${h}_{imag} = vec ( {H}_{imag}^{T} ) , \qquad ( 2 b )$$

resulting in hᵣₑₐₗ, h_{imag} ∈ [symbol] .
(3) Flattened components are divided into P/2 patches 133. Each patch has a length L=2MN/P. Patches are generated as follows

$${p}_{i} = {h}_{real} [ ( i - 1 ) L + 1 : iL ] , i ∈ [ P / 2 ] , \qquad ( 3 a )$$

$${p}_{i + P / 2} = {h}_{imag} [ ( i - 1 ) L + 1 : iL ] , i ∈ [ P / 2 ] , \qquad ( 3 b )$$

where each patch pᵢ ∈ [symbol] , with i ∈[P]={1, 2, . . . , P}. Selecting the patch size depends on the task's need for local versus global information and the available computational resources, rather than any specific threshold. By selecting a patch size that allows both detail and structure to be preserved, LWM captures features that represent variations while broad enough to generalize across tasks and datasets. In some configurations, a selected patch size is based on the performance of the masking strategy.

With respect to masked channel modeling 127, for LWM to be task-agnostic, it is pre-trained in a self-supervised manner. Self-supervised learning enables LWM to capture the intrinsic structure of the data, allowing it to serve as a universal feature extractor adaptable to various downstream tasks, without reliance on labeled data. Masked channel modeling (MCM) may enable self-supervised pre-training. In MCM, p % of the real part patches are masked. This percentage is chosen to balance the model's access to context with the challenge of reconstructing missing patches. Masking too many patches could lead to excessive information loss, making reconstruction difficult, while masking too few could provide limited incentive for the model to learn complex dependencies. Within the selected p % of patches, sub-percentages may be assigned. For example, 80% may be fully masked with a uniform vector m=[m, m, . . . , m]^{T} ∈ [symbol] , preventing the model from accessing information in those locations. In some configurations, LWM may use surrounding patches to predict the masked values, and learn the spatial dependencies within the channel. For a further example, 10% of the patches may be replaced with random vectors sampled from a distribution (e.g., [symbol] (0, σ²)), adding noise and encouraging LWM to differentiate genuine channel structures from anomalies. Still further, 10% of the patches may be left unchanged, providing partial ground truth to stabilize the model's predictions and helping it recognize real patterns among masked and altered patches. The masking strategy may be applied to both the real and imaginary parts to prevent information leakage between them. The imaginary patches selected for masking may be the exact counterparts of the randomly selected real patches, preventing indirect inference. If only the real part of a patch pᵢ were masked while leaving its imaginary part p_{i+P/2} unmasked, the model may use the unmasked imaginary patch p_{i+P/2} to predict pᵢ. By masking both components of each selected patch, LWM may learn each component's structure independently, resulting in robust feature extraction and reducing the chance of unintended data leakage.

The selected p % of patches may be masked before going through the input embedding, positional encoding, and finally the LWM pre-training stages. The corresponding high-dimensional embeddings of masked patches at the output of LWM pass through a linear layer that maps each embedding back to the original patch size. The goal is to minimize 137 the mean squared error (MSE) between the reconstructed masked patches and their original values, expressed as

$${ℒ}_{MCM} = \frac{1}{\vert ℳ \vert} {\sum }_{i ∈ ℳ} {‖ {W}^{dec} {e}_{i}^{LWM} - {p}_{i} ‖}^{2} \qquad ( 4 )$$

where [symbol] represents the set of all selected (masked) patches,

$${e}_{i}^{LWM} ∈ {ℝ}^{D}$$

is the high-dimensional embedding of the i-th masked patch at LWM's output, W^{dec}∈ [symbol] is the weight matrix of the linear layer used to map eᵢ back to the original patch size, and pᵢ is the original value of the i-th patch.

This approach allows LWM to develop embeddings that can be decoded using a linear layer. Because the Transformer encoder 103 does not know which patches will be masked or replaced by random patches, it maintains a contextual representation for every input patch. Additionally, as random replacement occurs for a small fraction of all patches (10% of the p % masked patches), the model's ability to capture spatial and structural dependencies remains unaffected. The LWM's output embeddings capture spatial relationships within the channel, enabling decoding and robust performance across downstream tasks.

The patches are concatenated into a new representation H′ ∈ [symbol] . The patch-based approach may accelerate computations, may enable the model to learn both inter- and intra-patch relationships, may mimic convolutional layers with self-attention, and may increase design flexibility.

Continuing to still further refer to FIG. 1A, with respect to patch classification (CLS), an additional patch 121, known as the classification patch, is prepended to the sequence 123, increasing the sequence length to P+1. The classification patch 121 may form an attention focal point by interacting with other patches through the self-attention mechanism, enabling the classification patch 121 to aggregate and summarize information from the sequence 123 into a smaller dimension. The aggregation and summarization of information from the sequence 123 enables understanding of the input.

The classification patch is initialized as a learnable vector, denoted p_{CLS}=[c, c, . . . , c]^{T} ∈ [symbol] , where c is set as a random value. Through its interactions across the Transformer layers, it aggregates and summarizes information from other patches in the sequence. This interaction enables the classification patch to capture a view of the input by attending to each patch in each layer, accumulating information from local details and broader structures. As the sequence passes through multiple Transformer layers, the classification patch's representation is refined, with each layer integrating lower-level details (e.g., spatial or temporal variations) and higher-level features (e.g., overall channel quality or dominant paths). The resulting representation,

$${e}_{CLS}^{LWM} ,$$

serves as a compact, high-level summary of the input sequence

$${e}_{CLS}^{LWM} = {f}_{LWM} ( {e}_{CLS} , {\{ {e}_{i} \}}_{i = 1}^{P} ) , \qquad ( 5 )$$

where ƒ_{LWM} represents the transformations and interactions within LWM. Through this mechanism, the classification patch identifies the patches that contribute most significantly to the structure and dependencies within the channel, highlighting the segments most critical in defining the channel's overall characteristics. Additionally, the compact size of the classification patch makes it an efficient, low-dimensional encoded representation of the channels. This compactness is advantageous, as it serves as an expressive summary without requiring further model training, given that LWM has already been pre-trained in a task-agnostic manner to capture these global features.

The attention scores assigned between the classification patch and each patch pᵢ reveal the relative importance of each patch, making the classification patch a valuable interpretability tool across various wireless tasks. For example, in channel estimation, the classification patch can highlight critical segments of the channel, such as those representing major multipath components, used for accurate channel estimation. In classification tasks such as line-of-sight (LoS) and non-line-of-sight (NLoS) classification, the classification patch summarizes the input, capturing the distinguishing features that identify LoS versus NLOS conditions. By attending to patches with high relevance to signal paths, reflection, and scattering, the classification patch representation

$${e}_{CLS}^{LWM}$$

captures a global context that is used for classification tasks to understand the channel state. Additionally, in resource allocation, the classification patch's attention scores

$${\{ {α}_{CLS , i} \}}_{i = 1}^{P}$$

(where α_{CLS,i} is the attention weight of the i-th patch with respect to the classification patch) help identify channel segments that demand more resources. This optimization supports spectrum and power allocation by prioritizing the most influential patches. In beamforming and beam selection, the classification patch can focus on patches that carry directional cues, assisting in adaptive beam selection by highlighting segments most indicative of optimal beam configurations. In semantic communications, the classification patch enables efficient encoding by capturing patches containing the most contextually relevant information, enhancing communication quality while reducing redundancy. These examples demonstrate the versatility of the classification patch across wireless applications, where it serves as an adaptable focal point for understanding and prioritizing channel features that directly impact performance.

Continuing to refer to FIG. 1A, with respect to channel embedding 129, after masking and prepending the classification patch to the channel patch sequence, the patches are projected into an embedding space with dimension D using a linear layer, effectively mapping the flattened patches to D-dimensional vectors. Given a set of patches

$$\{ {p}_{CLS} , {p}_{1}^{m} , {p}_{2}^{m} , ... , {p}_{P}^{m} \} , where {p}_{i}^{m} ∈ {ℝ}^{L}$$

represents a masked patch (with 15% of patches masked), the linear layer performs the following transformation for each patch

$${p}_{i}^{m}$$

$${e}_{i}^{emb} = {W}^{emb} {p}_{i}^{m} + b ∈ {ℝ}^{D} , i ∈ \{ CLS \} ⋃ [ P ] , \qquad ( 6 )$$

where W^{emb} ∈ [symbol] is the weight matrix, and b ∈ [symbol] is the bias vector for all patches. This transformation produces the initial patch embeddings

$${E}^{emb} = {[ {e}_{CLS}^{emb} , {e}_{1}^{emb} , {e}_{2}^{emb} , ... , {e}_{P}^{emb} ]}^{T} ∈ {ℝ}^{( P + 1 ) \times D} ,$$

allowing the Transformer to process all patches in a common high-dimensional feature space where relationships can be effectively captured.

Embedding patches into a high-dimensional space before feeding them into the Transformer captures complex relationships. A high-dimensional embedding enables the patches to retain fine-grained information about the channel data. The choice of a high embedding dimension D enables the Transformer to establish detailed contextual relationships, similar to how embeddings in text-based models capture the semantic relationships between words. In language models, embeddings allow each token (word or subword) to represent not only its isolated meaning but its meaning contextualized by surrounding words. This context-awareness handles nuances like polysemy. In wireless channels, high-dimensional embeddings enable patches to capture information with respect to the channel, representing dependencies between different parts of the channel and capturing structural nuances. In wireless channels, fine-grained details such as spatial correlations, multipath effects, and scattering may enable accurate representation. Positional encodings may be added to the embeddings to provide the Transformer with information about the order of patches. To achieve this, a positional encoding patch

$${p}_{i}^{pos} ∈ {ℝ}^{L}$$

is defined for each patch i.

For the classification token, the positional encoding patch is a uniform vector of zeros.

For each subsequent patch i ∈[P], the positional encoding patch is a uniform vector filled with the value i, providing an incremental encoding. Mathematically, this is expressed as

$${p}_{i}^{pos} = i \cdot {1}_{L} , i ∈ [ P ] , \qquad ( 7 )$$

where 1_{L} is a vector of ones in [symbol] . Each positional encoding patch

$${p}_{i}^{pos}$$

is mapped into the embedding space using a learned embedding matrix W^{pos} ∈ [symbol] and a bias vector b^{pos} ∈ [symbol] , resulting in positional encodings

$${e}_{i}^{pos} = {W}^{pos} {p}_{i}^{pos} + {b}^{pos} , i ∈ \{ CLS \} ⋃ [ P ] . \qquad ( 8 )$$

These position embeddings are then added to the corresponding patch embeddings eᵢ, yielding the position-encoded input embeddings

$${e}_{i}^{input} = {e}_{i}^{emb} + {e}_{i}^{pos} , i ∈ \{ CLS \} ⋃ [ P ] . \qquad ( 9 )$$

This addition forms the final set of position-encoded embeddings

$${E}^{input} = {[ {e}_{CLS}^{input} , {e}_{1}^{input} , {e}_{2}^{input} , ... , {e}_{P}^{input} ]}^{T} ∈ {ℝ}^{( P + 1 ) \times D} ,$$

effectively incorporating ordered context into each patch embedding for the Transformer model.

These position embeddings are then added to the corresponding patch embeddings eᵢ, yielding the position-encoded input embeddings

$${e}_{i}^{input} = {e}_{i}^{emb} + {e}_{i}^{pos} , i ∈ \{ CLS \} ⋃ [ P ] . \qquad ( 9 )$$

This addition forms the final set of position-encoded embeddings

$${E}^{input} = {[ {e}_{CLS}^{input} , {e}_{1}^{input} , {e}_{2}^{input} , ... , {e}_{P}^{input} ]}^{T} ∈ {ℝ}^{( P + 1 ) \times D} ,$$

effectively incorporating ordered context into each patch embedding for the Transformer model.

In some configurations, the patches are embedded 111 into an embedding dimension, for example, D=64, using a linear layer 125, allowing the Transformer 103 to connect the patches in context. Positional encodings 107 are added via a linear layer 125, for example. The final input to the Transformer 103 is Eᵢₙₚᵤₜ ∈ [symbol] .

A Transformer encoder architecture 103 is modified to accommodate the wireless channel context. The self-attention mechanism enables a patch in a sequence 123 to compute a weighted sum of values based on the similarity between query and key vectors. Given input Eᵢₙₚᵤₜ ∈ [symbol] , where P+1=129 is the sequence length and D=64 is the embedding size, self-attention is computed as follows. The model processes input embeddings through a sequence of E encoder blocks, progressively refining the embeddings to capture increasingly complex relationships and contextual patterns in the data. Across the n-th encoder block, where n ∈[E], the input embeddings

$${E}_{n}^{input} ∈ {ℝ}^{( P + 1 ) \times D}$$

evolve, with each layer enhancing feature richness. This sequence culminates in the final output embeddings, denoted as E^{LWM} ∈ [symbol] , which constitute the LWM embeddings, encapsulating a refined representation suitable for downstream tasks.

Within each encoder block, the input embeddings go through the following components sequentially: multi-head attention, layer normalization with residual connections, a feed-forward network, and another layer normalization with residual connections. Each component refines the embeddings by capturing different aspects of the data structure. The output from one encoder block serves as the input to the next block, enabling the model to progressively build complex representations that capture the dependencies within the wireless channels. The details of these model components at each encoder block are outlined herein.

The self-attention mechanism enables the patches in the input sequence to assign importance to all other patches, achieved through a dot-product similarity measure. Given input embeddings E^{input} ∈ [symbol] , where P is the number of patches and D is the embedding dimension, each row of E^{input} represents an embedding vector corresponding to a patch.

To compute self-attention, the query (Q), key (K), and value (V) matrices are derived using linear transformations, each defined by learned weights

$$Q = {E}^{input} {W}^{Q} , K = {E}^{input} {W}^{K} , V = {E}^{input} {W}^{V} , \qquad ( 10 )$$

where W^{Q}, W^{K}, W^{V} ∈ [symbol] . In some configurations, D′ is set to D for single-head attention but may vary to D_{H} for multi-head attention. In some configurations, D_{K}=5, and H=12.

Referring now to FIG. 1B, self-attention begins by calculating the scaled dot-product of the query and key matrices, capturing the similarity among patches in the input sequence. This similarity measure is computed as follows

$$S = \frac{Q {K}^{T}}{\sqrt{{D}^{′}}} , \qquad ( 11 )$$

where S represents the scaled similarity scores, and the scaling factor \sqrt{D′} prevents gradient issues like explosion or vanishing. These scaled similarity scores may be normalized by applying the softmax function

$$A = soft max ( S ) , \qquad ( 12 )$$

where A is the attention weight matrix, which ensures that the weights assigned to each patch sum to 1 for each query, allowing the model to focus selectively on the most relevant patches. Finally, the attention weights are used to compute a weighted sum of the value matrix, producing the attention output

$$Attention ( Q , K , V ) = A V \qquad ( 13 )$$

This process enables the model to dynamically adjust its focus based on the contextual relevance of each patch in relation to others, capturing local and global relationships across the input sequence.

The query, key, and value matrices in the self-attention mechanism represent distinct, interrelated aspects of each input patch, working together to capture local and global dependencies in the data. Each of these matrices has a specific purpose, ultimately contributing to how the model emphasizes certain relationships over others within the input sequence.

The query matrix encodes the intent or interest of each patch in the sequence, representing the way each patch seeks information relevant to itself from other patches. Queries help determine what aspects of the surrounding data are most pertinent to the current patch, as each query vector in Q is a question that asks how similar or relevant other patches are to it.

The key matrix complements the query matrix by encoding characteristics of each patch that can be evaluated by queries from other patches. While queries seek information, keys provide the attributes or features by which each patch can be “queried.” For any two patches, their query and key vectors are compared to assess their mutual relevance, which is captured through the dot product QK^{T}. High similarity scores indicate that certain patches carry information of high interest to one another.

The value matrix represents the actual information that each patch provides to the model, contributing to the weighted sum in the final self-attention calculation. Once the model identifies relevant patches (through the similarity scores from the dot product of queries and keys), the corresponding value vectors are aggregated based on their importance, defined by the computed attention weights. Values are akin to the content that is passed along in the attention mechanism, shaping the contextualized representation of each patch by integrating relevant details from others.

To better understand the roles of query, key, and value, consider the analogy of a conference setting in which each participant has specific interests or questions (queries) they want addressed. Each participant also has unique expertise (keys) they can offer. If someone's interest in one aspect aligns with another's expertise, a match occurs, enabling an exchange of knowledge (values). In self-attention, this relationship is formalized by computing the similarity between each query and the keys. When a query and key pair align, an attention weight is assigned, resulting in a weighted aggregation of the corresponding value vectors. Patches to gather information relevant to their contexts.

Queries, keys, and values facilitate a process where each patch determines which other patches to attend to, assigns importance to each based on their contextual relevance, and then updates its representation based on a weighted sum of the relevant information. This arrangement allows the Transformer model to dynamically focus on relationships across patches, enabling it to capture both immediate and extended dependencies in the data with great flexibility and precision.

Continuing to refer to FIG. 1B, multi-head attention 117 builds upon self-attention by enabling the model to learn multiple representations simultaneously. H independent self-attention mechanisms are applied, each with distinct learned weight matrices

$${head}_{h} = Attention ( {E}^{input} {W}_{h}^{Q} , {E}^{input} {W}_{h}^{K} , {E}^{input} {W}_{h}^{V} ) , \qquad ( 14 )$$

$$where {W}_{h}^{Q} , {W}_{h}^{K} , {W}_{h}^{V} ∈ {ℝ}^{D \times {D}_{H}}$$

are the transformation matrices specific to each head, and D_{H}=└D/H┘. For example, H=12 heads. By processing across multiple heads, the model learns representations from various subspaces of the data, enhancing its ability to capture nuanced relationships. The outputs of the heads are concatenated and passed through a linear transformation

$$Multi - head ( Q , K , V ) = Concat ( {head}_{1} , … , {head}_{H} ) {W}^{o} , \qquad ( 15 )$$

where W⁰ ∈ [symbol] . This combined output from multiple heads enables the model to focus on diverse aspects of the input sequence simultaneously, enriching the feature representation by capturing different patches and interactions in parallel.

Each attention head can be thought of as a unique lens through which the model interprets the input data. In a multi-faceted problem space, these different lenses enable the model to pick up on varying levels of detail and relational structures simultaneously. For example, if each participant in a conference has a set of questions (queries) and expertise (keys) but can also approach the conversation from multiple viewpoints or specializations (e.g., technical details, future trends, industry applications), one head might focus on broad concepts (like general channel structure or coarse spatial relationships), while another might pick up fine-grained, detailed aspects (such as precise timing or frequency patterns).

Referring again to FIG. 1A, each encoder layer includes a feed-forward network 119 that processes individual patch embeddings independently. Formally, the FFN applies two linear transformations separated by a non-linear ReLU activation

$$F F N ( {e}_{i} ) = max ( 0 , {e}_{i} {W}_{1} + {b}_{1} ) {W}_{2} + {b}_{2} , \qquad ( 16 )$$

where W₁ ∈ [symbol] , W₂ ∈ [symbol] , The intermediate layer size D_{FF}=TD expands the embedding dimension by a factor of T, which empirically improves the model's expressiveness. The FFN enriches each embedding with more complex transformations, and because each embedding is processed separately, the FFN layer does not introduce dependencies across patches.

Layer normalization 135 stabilizes the training by ensuring that each layer's output has zero mean and unit variance

$$LayerNorm ( {e}_{i} ) = \frac{{e}_{i} - {μ}_{i}}{{σ}_{i}} , \qquad ( 17 )$$

where μᵢ and σᵢ denote the mean and standard deviation across the feature dimension of each patch embedding e. This normalization is essential for convergence, especially in deeper networks, as it reduces covariate shifts.

Residual connections are added around each sub-layer (self-attention and FFN) to improve gradient flow

$${Output}_{i} = LayerNorm ( {e}_{i} + sub - layer ( {e}_{i} ) ) . \qquad ( 18 )$$

The addition operation allows gradient information to flow more directly through the network, mitigating vanishing gradient problems and enabling efficient backpropagation.

Continuing to refer to FIG. 1A, LWM is pre-trained 109 to be used in multiple downstream tasks. In some configurations, the LWM pre-training process may use a dataset of over 1 million wireless channels from 15 scenarios within the DeepMIMO dataset, with 80% of the data dedicated to training and 20% to validation. These scenarios may include, for example, 01, Boston5G, ASU Campus, New York, Los Angeles, Chicago, Houston, Phoenix, Philadelphia, Miami, Dallas, San Francisco, Austin, Columbus, and Seattle. The first three scenarios are larger, while the remaining twelve city scenarios average around 1500 effective users each. In wireless communications and sensing, relationships within the data may include dependencies across various dimensions, and the model captures local patterns and broader spatial structures. Transformers are trained on large-scale and diverse datasets, as these enable them to generalize and learn complex relationships. Training on such a dataset may enable LWM to capture nuanced wireless patterns, preparing it for downstream tasks.

As an example, the wireless channels in the dataset may be structured as (M, N)=(32,32) matrices, where N corresponds to the number of subcarriers and M to the number of antennas. To prepare these data for Transformer processing, each channel matrix H ∈ [symbol] is split into P=128 patches: 64 from the real part and 64 from the imaginary part. Each patch contains values from L=16 consecutive subcarriers out of the 32 total subcarriers, spanning each antenna, resulting in patches of size 16×1.

For self-supervised learning, in the example, the masked channel modeling (MCM) technique is applied. Specifically, 9 out of 64 real-part patches are randomly masked (approximately 15% of patches), with the corresponding imaginary-part patches masked similarly to prevent data leakage. Masking is conducted based on three probability-based actions. With probability 0.1, patches are replaced with a random vector. With probability 0.8, patches are replaced with a uniform mask array (value m=1). With probability 0.1, the patches remain unchanged. This approach enables LWM to learn contextual relationships across masked and unmasked patches, facilitating effective feature extraction from wireless channels. Because LWM does not know which patches are masked, LWM understands inter- and intra-patch relationships, including the masked patches. When the loss function is optimized based on the masked patches, LWM captures a representation across the input. The objective is to minimize the prediction loss by selecting LWM embeddings

$${e}_{i}^{LWM}$$

selected (masked) patches [symbol] and minimizing

$${min}_{{W}^{d e c} , Θ} {\sum }_{i ∈ ℳ} {‖ {W}^{d e c} {e}_{i}^{L W M} - {p}_{i} ‖}^{2} , \qquad ( 19 )$$

where Θ represents the parameters of the LWM model. This optimization encourages the model to learn mappings that accurately reconstruct masked patches from the embeddings, refining its ability to capture critical context from both masked and unmasked channel sections.

After masking, a classification patch vector P_{CLS}, initialized with random values, is prepended to the start of the channel patch sequence. Each 16×1 patch vector is then projected into a D=64-dimensional space via a linear layer, yielding embeddings

$${e}_{i}^{emb} ∈ {ℝ}^{64}$$

for each patch. These embeddings are further enriched with positional encodings to capture structural dependencies critical for learning within wireless channel data. The final input embedding matrix E^{input} ∈ [symbol] consolidates spatial and frequency information from both real and imaginary components, ready for processing through LWM's transformer-only encoder.

LWM uses MSE loss instead of the cross-entropy loss commonly found in natural language processing models like BERT. In language models, cross-entropy loss is effective for predicting discrete tokens from a fixed vocabulary, as in Masked Language Modeling (MLM), where masked tokens are classified based on surrounding context

$${ℒ}_{M L M} = - {\sum }_{i ∈ ℳ} log p ( {y}_{i} \vert {e}_{i}^{B E R T} ) , \qquad ( 20 )$$

where [symbol] represents masked positions, y; is the true token, and

$$p ( {y}_{i} \vert {e}_{i}^{B E R T} )$$

is the predicted probability. This approach works for discrete data but is unsuitable for continuous-valued wireless channels, which lack a fixed vocabulary. Instead, LWM treats masked channel modeling (MCM) as a regression task, using MSE loss (4) to measure the error between predicted and actual masked patch values. This allows LWM to learn spatial and temporal dependencies from surrounding unmasked patches, developing robust feature representations tailored to the continuous nature of wireless channels.

TABLE I
LWM Pre-training Setup Parameters

| Parameter | Value |
|---|---|
| Antennas at BS (N) | 32 |
| Antennas at UEs | 1 |
| Subcarriers (M) | 32 |
| Patch Size (L) | 16 |
| Embedding Size (D) | 64 |
| Channel Patches (P) | 128 |
| Attention Heads (H) | 12 |
| Encoder Layers (E) | 12 |
| FFN Hidden Size (D_{FF}) | 256 |
| Head Dimension (D_{H}) | 5 |
| Masking Percentage (p) | 15 (80/10/10) |
| Learning Rate | 1 × 10⁻⁴ |
| Batch Size | 64 |
| Optimizer | Adam |
| Adam β₁ | 0.9 |
| Adam β₂ | 0.999 |
| Adam ϵ | 1 × 10⁻⁸ |
| Weight Decay | 1 × 10⁻⁵ |
| Dropout Rate | 0.1 |
| Model Parameters | 600K |
| Training Set Size | 820K |
| Validation Set Size | 200K |

As shown in Table I, an exemplary pre-training setup for LWM includes 12 attention heads, 12 encoder layers, an embedding size of 64, and an FFN hidden size of 256. In the example, training begins with a learning rate of 1×10⁻⁴, decreasing by 10% every 10 epochs to ensure smooth convergence. A batch size of 64 is used, along with the Adam optimizer (β₁=0.9, β₂=0.999, eps=1×10⁻⁸), and a weight decay of 1×10⁻⁵ to reduce overfitting. The 12-head attention mechanism enables the model to capture multiple relationships within the data, while the depth of the encoder layers allows it to extract local and global patterns in the channels. This setup can enable learning while balancing convergence and generalization across various wireless communication scenarios.

By the end of pre-training, LWM may produce contextual embeddings from raw wireless channels. The integration of channel preprocessing, self-supervised learning, bidirectional attention, and multi-head attention mechanisms enables the model to generalize effectively across a range of scenarios, enabling it to extract features for diverse downstream tasks in wireless communications and sensing systems.

The model uses a self-supervised method to develop a universal feature extractor for contextualized channel embeddings. The model employs attention to predict masked patches, learning input relationships. Unlike pre-trained language models that use a Transformer architecture to understand the context of words in text and predict tokens from a discrete vocabulary using cross-entropy loss, LWM processes wireless channels and minimizes 137 prediction error with mean squared error (MSE). The prediction is achieved using a linear layer 125 on top of the pre-trained model with high generalizability based on features extracted by self-attention.

A combination of, for example, but not limited to, fifteen scenarios from, for example, the DeepMIMO dataset, including over a million ray-traced wireless channels, may be used to train the Transformer 103.

In some configurations, the LWM embeddings include P+1 patches in a different dimension. The embeddings are represented as E_{LWM}=[C E^{T}]^{T} ∈ [symbol] , where C ∈ [symbol] is a relatively lower-dimensional output classification embedding 139, and E ∈ [symbol] are the relatively higher-dimensional channel embeddings 129. LWM embeddings are generated in realtime and capture patterns.

To compare embedding and raw channels, a similar complexity for a downstream model 141 is chosen for both, selecting a model optimized for raw channels as the performance benchmark. A model architecture with comparable parameters is used. A residual 1D CNN is used to capture patterns while minimizing overfitting through residual connections and weight-sharing. Beam prediction may be used to compare raw channels and embeddings. Ground-truth optimal beams are computed for each user, generating a labeled dataset, with complexity varied by adjusting the codebook size from 16 to 256 beams. Performance is evaluated across different training data percentages. Additionally, LWM embeddings for Line-of-Sight (LoS) and Non-Line-of-Sight (NLoS) classification and beamforming optimization are assessed.

To exercise a system and method in accordance with embodiments of the present disclosure, six scenarios from the DeepMIMO dataset which were not included in LWM's pre-training, including a total of 14840 samples, are used. The dataset is split into 70% for training, 20% for validation, and 10% for testing. For LWM embeddings, the raw channels are first processed through the pre-trained LWM model in realtime to generate embeddings, which are then used as input for the downstream model.

LWM generates context-aware embeddings from raw wireless channels in real-time, with no need for additional training for embedding generation. Pre-trained on large, diverse datasets using a self-supervised, Transformer-based approach, it allows users to immediately obtain high-quality, low- and high-dimensional embeddings suitable for a wide array of downstream tasks. The pre-trained model can be employed as-is, leveraging these embeddings directly, or the model's last layers can be fine-tuned to extract highly task-specific, fine-grained features. This flexibility makes LWM highly adaptable, enabling it to capture both local and global patterns and perform effectively across general and specialized scenarios, even in data-scarce environments.

The inference process begins with segmenting the raw wireless channel data into patches, embedding them, and adding positional encodings, similar to the pre-training phase but without the need for masking or weight updates. This structured approach allows LWM to extract and represent multi-scale patterns from small and large contexts within the data. The resulting embeddings, E^{LWM}=[e_{CLS}^{LWM}, e₁^{LWM}, e₂^{LWM}, . . . , e_{P}^{LWM}]^{T}=[C E^{T}]^{T} ∈R^{(P+1)×D}, include the classification embedding C ∈R^{D} and the channel embeddings E ∈R^{P×D}.

The classification embedding provides a channel representation, supporting, for example, but not limited to, LoS/NLOS classification, while channel embeddings, four times larger than the input, capture intricate spatial and frequency dependencies for more detailed applications. This inference setup offers advantages, including usability, as pre-trained embeddings can be applied without retraining, enabling deployment in resource-limited scenarios. LWM captures local and global channel patterns, ensuring adaptability to tasks requiring fine-grained or high-level insights. Additionally, its flexibility allows users to cither apply embeddings as-is or fine-tune the last layers for task-specific improvements without retraining the full model. LWM generalizes even in data-scarce environments, leveraging its pre-trained representations to maintain performance with minimal labeled data. By balancing detailed feature extraction with computational efficiency, LWM provides a practical and adaptable solution for various wireless communication tasks.

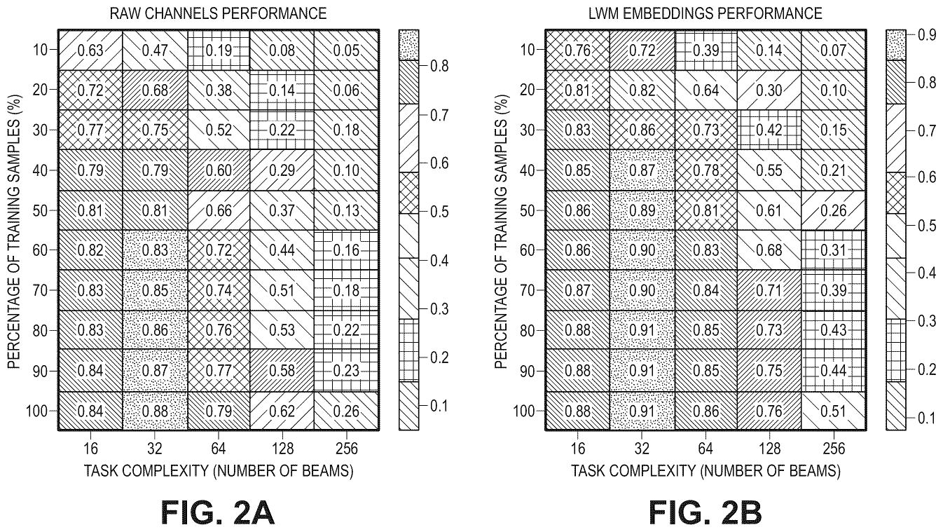

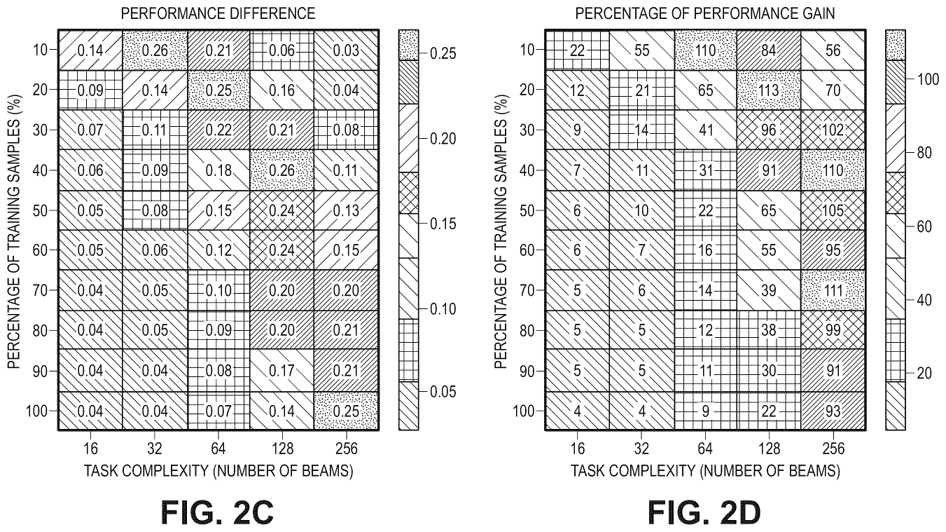

Referring now to FIGS. 2A and 2B, a comparison of the performance between raw channels and LWM channel embeddings in training a model for beam prediction, evaluated across different codebook sizes and varying amounts of training data, is shown. As shown in FIG. 2A, raw channels require more data to reach high performance levels, while LWM channel embeddings achieve performance saturation with just 50%-70% of the available data and consistently outperform raw channels. Notably, as shown in FIG. 2B, LWM embeddings reach the benchmark performance of raw channels with only 40%-50% of the data, regardless of task complexity, highlighting the data efficiency of LWM embeddings.

Referring now to FIGS. 2C and 2D, the F1-score difference heatmap in FIG. 2C highlights where embeddings surpass raw channels, aiding in model optimization for complex or low-data tasks. The F1-score gain percentage heatmap in FIG. 2D emphasizes the efficiency of embeddings, showing how they scale with fewer resources. FIG. 2C demonstrates that embeddings are effective when data are limited relative to task complexity. The performance difference follows a concave trend, where an initial increase in data improves performance, but beyond a certain point, the difference diminishes and gradually decreases, though it never turns negative.

In an exemplary application, to predict the strongest mm Wave beam at the receiver from a predefined codebook at the base station, based on Sub-6 GHz channels, the following steps may be performed. In the case of channel mapping, instead of directly predicting mmWave channels, the model learns the relationship between Sub-6 GHz channels and a mmWave beam. Groundtruth optimal beams are computed for each user, generating a labeled dataset. The task complexity is varied by adjusting the codebook size, ranging from 16 to 256 beams. Performance is evaluated across different training data percentages to assess how well the model generalizes with less data. This makes the example practical because it reduces the overhead of full mmWave channel estimation. The example tests how well LWM embeddings capture the spatial and propagation characteristics of Sub-6 GHz channels and generalize to higher-frequency mm Wave beams.

LWM embeddings can be applied in additional tasks. For example, the smaller classification embeddings outperform raw channels in LoS/NLOS classification, achieving an F1-score of 0.87 with only thirteen training samples, compared to 0.55 for raw channels. While the gap narrows with more data, raw channels do not surpass the embeddings. Additionally, in robust beamforming optimization, LWM embeddings outperform raw channels, achieving an MSE of 0.01 compared to 0.51, highlighting their broader applicability beyond classification.

To evaluate the model, and to ensure fair comparison, similar downstream model complexity is used for both embeddings and raw channels, selecting a model optimized for raw channels as the performance benchmark. A uniform Residual ID-CNN architecture with 500K parameters is employed, designed to capture complex patterns through residual connections and weight-sharing while avoiding overfitting. The model includes an initial convolution layer followed by three residual blocks, each containing several convolution layers that extract deeper features. This is followed by global average pooling and fully connected layers for final classification. When parameters exceed 500K, the model overfits to raw channels, which is why we consider this architecture the benchmark for raw channels.

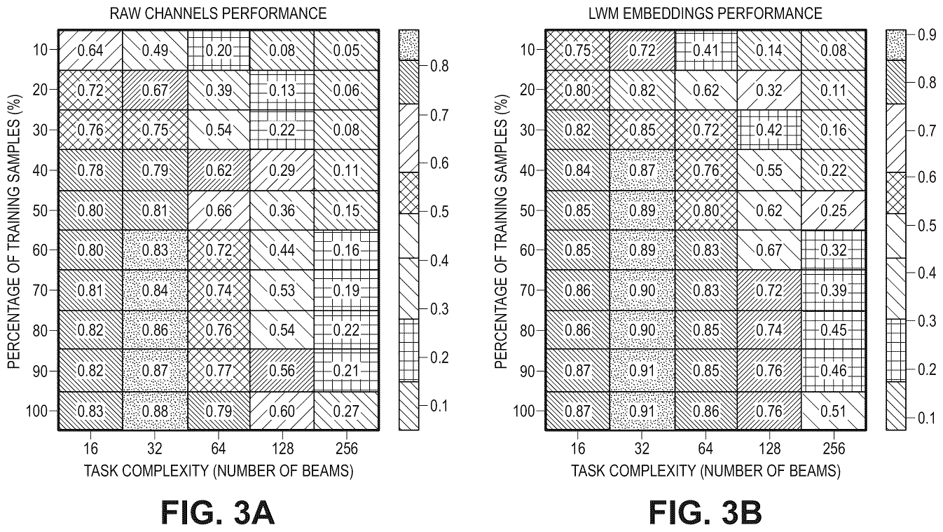

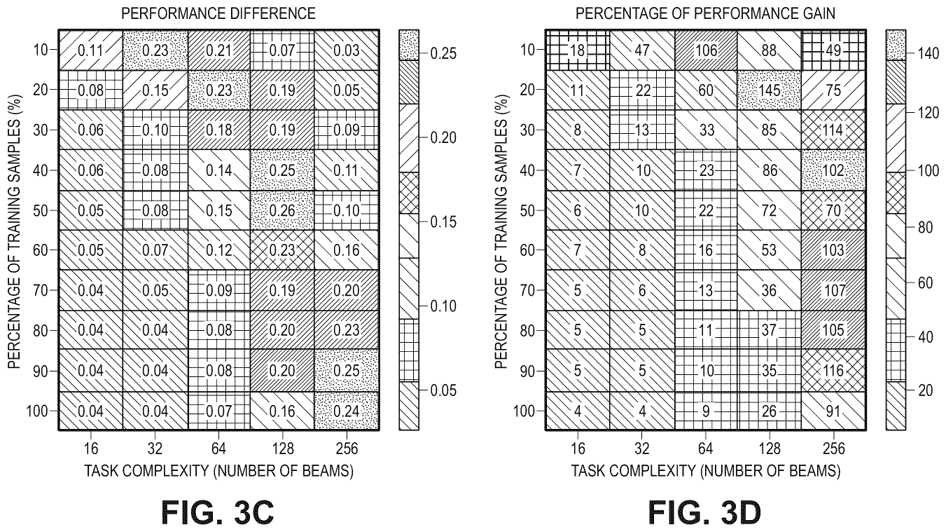

Referring now to FIGS. 3A-3D, a comparison of the performance between raw channels (FIG. 3A) and LWM channel embeddings (FIG. 3B) in training a model for beam prediction, evaluated across different codebook sizes and varying amounts of training data, is shown. As shown in FIG. 3A, the downstream models trained with raw channels require more data to reach high performance levels, while LWM channel embeddings (FIG. 3B) usually achieve performance saturation with just 50%—70% of the available data, and consistently outperform raw channels. LWM embeddings reach the benchmark performance of raw channels with only 40%-50% of the data, regardless of task complexity.

F1-score is used for classification tasks as it accounts for imbalanced labels and provides a clearer evaluation of model performance than accuracy. The F1-score difference heatmap in FIG. 3C highlights where embeddings surpass raw channels, aiding in model optimization for complex or low-data tasks. The F1-score gain percentage heatmap in FIG. 3D illustrates the efficiency of embeddings, showing how they scale with fewer resources. FIG. 3C demonstrates that embeddings are effective when data are limited relative to task complexity. The performance difference follows a concave trend, where an initial increase in data improves performance, but beyond a certain point, the difference diminishes and gradually decreases, though it never turns negative.

As the task complexity increases, such as with a higher number of labels, larger datasets illustrate the advantages of embeddings in capturing intricate patterns and dependencies.

This task serves as a benchmark to evaluate classification embeddings, which provide a highly compressed but more informative representation of raw channels. These embeddings capture the features of a channel, making them suitable for various tasks that require an understanding of the channel's behavior. In applications like channel state information, the classification embeddings can reduce the overhead of sending full channel data to the base station, for example, in multi-vendor environments. The LWM model functions like an encoder, delivering a compact yet illustrative version of the channel. This makes it suitable for tasks that need a comprehensive understanding of channel characteristics while significantly reducing transmission complexity.

The classification model is a downstream network for raw channels, classification embeddings, and channel embeddings, maintaining a consistent architecture across different input representations. The classification model begins with a fully connected layer, followed by batch normalization, ReLU activation, and dropout to enhance stability and prevent overfitting. The pattern continues through various layers, refining the features hierarchically. The final linear layer maps the processed representation to LoS/NLoS classes.

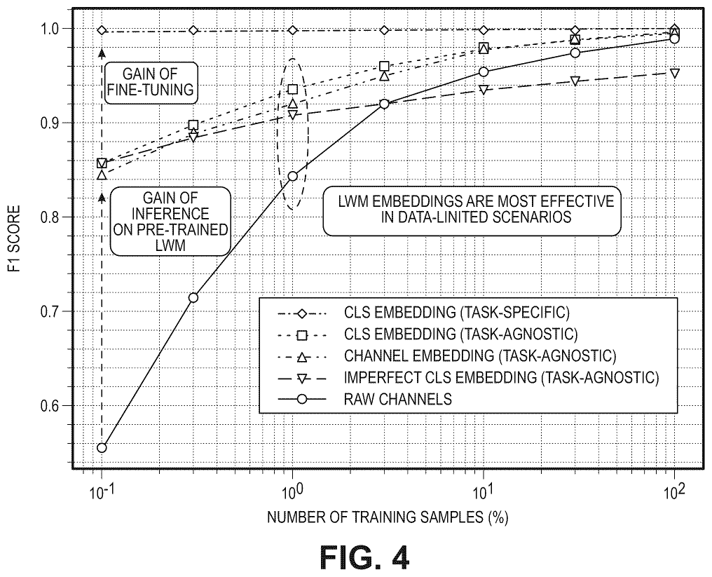

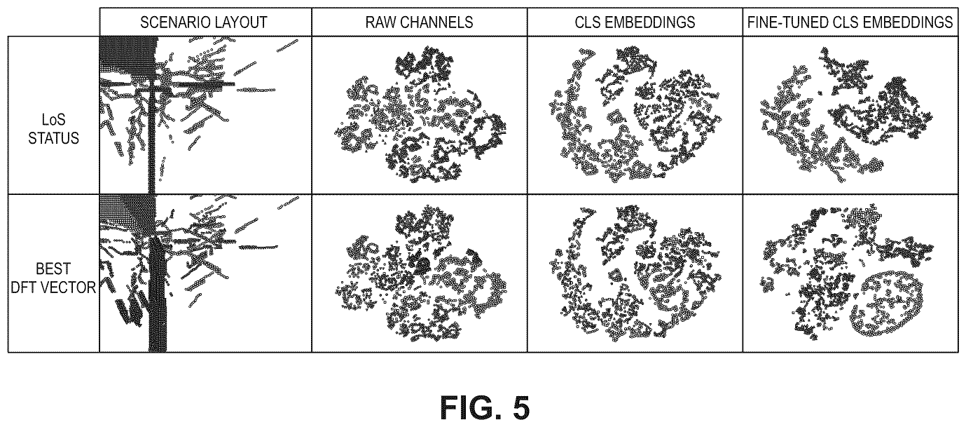

Referring now to FIGS. 4 and 5, classification embeddings are 32× smaller than raw channels, while channel embeddings are 4× larger. Classification embeddings inferred from noisy (imperfect) raw channels are included to demonstrate LWM's robustness to noise. Batch normalization accelerates convergence, while dropout improves generalization. FIG. 4 illustrates LWM's capabilities in data efficiency, lightweight adaptation, and noise robustness. The downstream model is evaluated using five input types: (i) classification embeddings (first-patch representation from frozen pre-trained LWM), (ii) channel embeddings (remaining patches of general-purpose embeddings), (iii) raw channels (unprocessed channels), (iv) classification embeddings inferred from imperfect raw channels corrupted with complex Gaussian noise (SNR=5 dB), and (v) fine-tuned classification embeddings. General-purpose embeddings are extracted from the pre-trained LWM without weight updates, while finetuned embeddings are generated by updating the last three layers of LWM jointly with the downstream task. This setup isolates the role of pre-trained feature hierarchies versus task-adaptive refinement. The comparison across input types quantifies LWM's ability to balance noise suppression, data efficiency, and task-specific discriminability-key strengths for deployment in resource-constrained wireless environments.

User channels are projected into 2D using t-SNE, comparing raw channels, task-agnostic (general-purpose) LWM embeddings, and fine-tuned LWM embeddings for each task. Classification embeddings clearly separate LoS and NLOS channels, enabling high zero-shot classification and strong initialization for downstream training with minimal data. Fine-tuning further enhances downstream task performance. The evaluation shows that, with only six training samples, models trained on raw channel data perform slightly better than random guessing (average F1-score=0.55), whereas general-purpose embeddings improve performance by +0.31 F1, demonstrating strong class separation in the embedding space. Fine-tuned embeddings enable class differentiation (F1≈1.0) even with minimal data, achieved by unfreezing and updating the last three layers of LWM alongside the downstream model—a strategy grounded in empirical evidence that earlier layers encode coarse-grained patterns (e.g., syntax and morphology in LLMs), while deeper layers refine task-specific details (e.g., signal variations). Classification embeddings outperform channel embeddings in low-data regimes, as channel embeddings capture complex patterns requiring larger datasets for effective utilization. Channel embeddings slightly surpass classification performance as training samples grow, leveraging their information density. Classification embeddings exhibit robustness to noise, aligning closely with their noisy counterparts, which highlights the LWM's ability to filter noise via self-attention in unseen environments. The fine-tuning strategy—limited to deeper layers—preserves pretrained knowledge of coarse signal characteristics (e.g., propagation geometry), preventing overfitting on small LoS/NLOS datasets, while enabling adaptation to subtle discriminative features. For more complex tasks, such as beam prediction, full-model fine-tuning becomes necessary.

LWM's Transformer-based architecture uses self-attention to model spatial and spectral dependencies in wireless channels, offering advantages over conventional signal processing methods. Unlike CNNs, which rely on local receptive fields, self-attention enables global feature extraction, capturing relationships across frequency and spatial domains in a single layer. This mechanism dynamically assigns importance scores to different patches, allowing the model to prioritize dominant channel components while suppressing noise and interference, making it well-suited for complex and dynamic wireless environments. LWM's bidirectional attention enables each patch to attend to both preceding and following patches, capturing inter-subcarrier dependencies and spatial correlations for improved modeling of multipath propagation.

A strength of self-attention in LWM is its potential for interpretability and sensitivity analysis in wireless communications. Unlike traditional deep learning models, where feature extraction remains opaque, attention scores offer direct insight into how different channel components contribute to predictions. By analyzing these scores, wireless engineers can assess which subcarriers, antennas, or spatial regions are most influential, enabling improved resource allocation, interference mitigation, and adaptive beamforming strategies. This is particularly valuable in channel state information compression, where prioritizing informative channel components can reduce feedback overhead without sacrificing performance.

Multi-head attention enhances interpretability by providing a layered perspective on wireless channels. Each attention head captures different propagation characteristics. One may focus on local variations in signal strength, while another may identify global trends across subcarriers. This allows for sensitivity analysis, helping researchers understand how different signal components impact model predictions under varying signal-to-noise ratio conditions. By tracking attention shifts across different environments, engineers can evaluate robustness to channel variations, identify learning weaknesses, and refine architectures for real-world deployment.

LWM's self-attention framework transforms wireless feature extraction into an interpretable and adaptive process. With its ability to highlight channel features, facilitate sensitivity analysis, and dynamically adjust to varying conditions, LWM is a tool for optimizing wireless system design and performance. MCM pre-trains LWM by randomly masking subsets of input channel patches and optimizing the model to reconstruct them via contextual dependencies learned through self-attention. Unlike conventional denoising techniques, MCM enforces hierarchical feature disentanglement, compelling the encoder to capture invariant physical-layer structures (e.g., multipath delay profiles, spatial-spectral correlations) while discarding transient noise artifacts. By training on partial observations, LWM's transformer layers develop noise-robust latent representations, where the classification token aggregates global signal statistics to infer missing or corrupted patches. This self-supervised objective aligns embeddings with channel semantics, enabling joint denoising and feature extraction without noise modeling. The result is a framework that suppresses interference (e.g., fading, estimation errors) while preserving discriminative patterns for downstream tasks, bridging robustness and adaptability in dynamic wireless environments.

Autoencoders (AEs) and LWM differ in implementation. AEs prioritize lossless reconstruction fidelity. LWM emphasizes semantic feature recovery (e.g., multipath structure, spatial correlations) to build universal channel understanding. AEs produce low-dimensional latent vectors, and LWM isolates a single classification token from its full embedding sequence. AE embeddings remain tightly coupled to decoder-dependent reconstruction, limiting their plug-and-play adaptability. LWM's classification token distills global channel semantics into a task-agnostic representation, enabling direct compatibility with diverse downstream tasks (classification, regression, decision-making) without architectural overhauls. Thus, while both architectures compress inputs into compact representations, LWM's embeddings prioritize versatile feature abstraction over pixel-perfect reconstruction, making them inherently adaptable to dynamic wireless decision-making workflows.

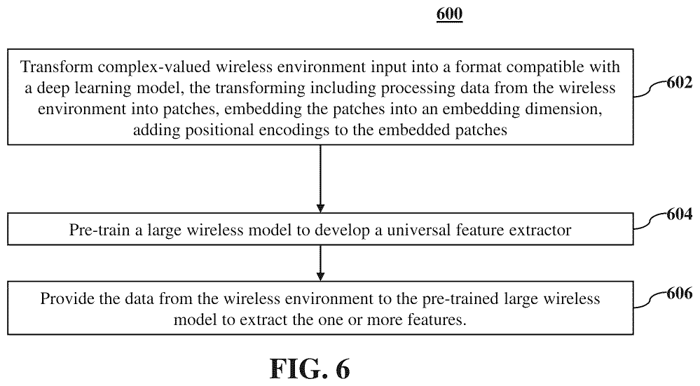

Referring now to FIG. 6, a method 600 for extracting features in wireless channels may include, but is not limited to including, transforming 602 complex-valued wireless channel input into a format compatible with a deep learning model. The transforming may include processing the wireless channels into patches, embedding the patches into an embedding dimension, and adding positional encodings to the embedded patches. The method 600 may also include pre-training 604 a large wireless model to develop a universal feature extractor, and providing 606 the wireless channels to the pre-trained large wireless model to extract the one or more features.

Notwithstanding that the numerical ranges and parameters setting forth the broad scope of the disclosure are approximations, the numerical values set forth in the specific examples are reported as precisely as possible. Any numerical value, however, inherently contains errors resulting from the standard deviation found in their respective testing measurements. Moreover, ranges disclosed herein are to be understood to encompass sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to one of several implementations, such feature may be combined with one or more other features of the other implementations as may be desired and advantageous for any given or particular function. As used herein, the terms “a”, “an”, and “the” may refer to one or more elements or parts of elements. As used herein, the terms “first” and “second” may refer to two different elements or parts of elements. As used herein, the term “at least one of A and B” with respect to a listing of items such as, for example, A and B, means A alone, B alone, or A and B. Those skilled in the art will recognize that these and other variations are possible. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the intended purpose described herein. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

1. A method for extracting features in a wireless environment, the method comprising:
transforming complex-valued wireless environment input into a format compatible with a deep learning model, the transforming including:
processing data from the wireless environment into patches;
embedding the patches into an embedding dimension; and
adding positional encodings to the embedded patches;
pre-training a large wireless model to develop a universal feature extractor; and
providing the data from the wireless environment to the pre-trained large wireless model to extract the one or more features.

2. The method of claim 1, wherein the deep learning model comprises:
a Transformer architecture.

3. The method of claim 1, further comprising:
computing, by the large wireless model, self-attention.

4. The method of claim 3, wherein computing self-attention comprises:
deriving query, key, and value matrices using learned weight matrices.

5. The method of claim 4, wherein the self-attention comprises:
scaled dot-product attention computed by taking a dot product of the query and key matrices, scaling by a pre-selected value, and applying a softmax function.

6. The method of claim 4, wherein the self-attention comprises:
multi-head attention computed by concatenating outputs from heads and linearly transforming the concatenated outputs using a weighted matrix.

7. The method of claim 1, further comprising:
applying, by the large wireless model, a feed-forward network to the patches to configure an encoder layer.

8. The method of claim 7, wherein the feed-forward network comprises:
a plurality of linear transformations with a ReLU activation between individual of the plurality of linear transformations.

9. The method of claim 7, further comprising:
normalizing, by the large wireless model, the encoder layer.

10. The method of claim 1, wherein the large wireless model comprises:
a residual connection in an encoder block.

11. The method of claim 1, wherein the large wireless model comprises:
one or more encoder blocks.

12. The method of claim 1, wherein processing of the data from the wireless environment comprises:
splitting the data from the wireless environment into overlapping or non-overlapping patches.

13. The method of claim 12, wherein splitting the data from the wireless environment comprises:
separating real components and imaginary components of the data from the wireless environment;
flattening the separated components;
dividing the real components and the imaginary components into a pre-selected number of the patches; and
concatenating the patches.

14. The method of claim 13, further comprising:
pre-processing data for training the model including performing masked channel modeling on the patches.

15. The method of claim 14, wherein the masked channel modeling comprises:
selecting a pre-selected percentage of the real components with 80% masked, 10% replaced with random vectors, and 10% left unchanged; and
selecting a pre-selected percentage of the imaginary components with 80% masked, 10% replaced with random vectors, and 10% left unchanged.

16. The method of claim 1, wherein the wireless environment comprises wireless communications and wireless sensing.

17. The method of claim 1, wherein providing the wireless channels to a pre-trained large wireless model comprises:
pre-pending an additional patch to the patches, the additional patch configured to interact with the patches to aggregate and summarize information from the patches.

18. The method of claim 1, further comprising:
segmenting the data from the wireless environment into two-dimensional patches spanning antenna and subcarrier dimensions; and
grouping the data of equivalent size from the wireless environment into buckets.

19. A computer system for extracting features in a wireless environment, the computer system comprising:
a hardware processor;
a non-volatile storage medium storing instructions that when executed by the hardware processor perform operations comprising:
transforming complex-valued wireless environment input into a format compatible with a deep learning model, the transforming including:
processing data from the wireless environment into patches;
embedding the patches into an embedding dimension; and
adding positional encodings to the embedded patches;
pre-training a large wireless model to develop a universal feature extractor; and
providing the data from the wireless environment to the pre-trained large wireless model to extract the one or more features.

20. A computer program product for extracting features in a wireless environment, the computer program product comprising:
a computer readable medium configured with instructions to perform operations including:
transforming complex-valued wireless environment input into a format compatible with a deep learning model, the transforming including:
processing data from the wireless environment into patches;
embedding the patches into an embedding dimension; and
adding positional encodings to the embedded patches;
pre-training a large wireless model to develop a universal feature extractor, and
providing the data from the wireless environment to the pre-trained large wireless model to extract the one or more features.
